(19) United States
(12) Patent Application Publication
(10) Pub. No.: US 2019/0069531 A1
(43) Pub. Date: Mar. 7, 2019

(54) DROPPER HOOK

(71) Applicants: Andrew Michael Ashmore, Austin, TX (US); David Murphy Ashmore, Austin, TX (US)

(72) Inventors: Andrew Michael Ashmore, Austin, TX (US); David Murphy Ashmore, Austin, TX (US)

(21) Appl. No.: 15/695,613

(22) Filed: Sep. 5, 2017

(51) Int. Cl. A01K 83/02; A01K 83/06; A01K 83/04

(52) U.S. Cl. CPC A01K 83/02; A01K 99/00; A01K 83/04; A01K 83/06

(57) ABSTRACT

A fish hook system includes a shank forming a bend and a barb on a first end, a first eyelet connected to the shank on a second end, and a second eyelet connected to the shank opposing the bend and the barb. The second eyelet is located either adjacent the first eyelet near the second end, along the shank near commencement of the bend, or along the bend of the shank diametrically opposed to the first eyelet.

### FIELD OF INVENTION

The invention is generally related to the field of fishing hooks and more particularly relates to fishing hooks adapted for attachment of a dropper, such as, for example, additional flies, baits, lures, indicators, stimulators and weights.

### BACKGROUND

Conventional fish hooks and riggings fail to provide an efficient way to add additional flies, baits, lures, indicators, stimulators or weights. A practice has been to tie fishing line into the bend of a hook to create so-called “drops” from the hook. These drops then allow additional items to be attached to the fishing line extending from the hook.

The conventional drops fastened by fishing line to the bend of the hook tend to slide along the body of the hook. This can cause break of the fishing line due to friction. The conventional drops can also be difficult to maneuver and retrieve when operating a boat in moving water or managing multiple anglers at once. Moreover, the conventional drops can result in dislodgement of the primary hook from which the drop is attached, such as when a secondary hook is connected to an object and pulls the primary hook out backwards.

It would, therefore, be a significant improvement in the art and technology to provide dropper hooks that overcome the problems of the conventional art.

### SUMMARY

An embodiment of the invention is a system including a shank forming a bend and a barb on a first end, a first eyelet connected to the shank on a second end, and a second eyelet connected to the shank opposing the bend and the barb.

Another embodiment of the invention is a method including providing a first eyelet, providing a bend to a shank connected by a first end to the first eyelet, providing a barb to a second end of the shank opposite the first eyelet, and providing a second eyelet to the shank.

Yet another embodiment of the invention is a fish hook including a shank forming a relatively straight portion and extending to a bend portion, a first eyelet at a first end of the relatively straight portion of the shank opposite the bend portion, a barb at a second end of the bend portion of the shank opposite the relatively straight portion, and a second eyelet connected to the shank.

Another embodiment of the invention is a method including providing a fish hook including a first eyelet and a second eyelet connected by a shank having a relatively straight portion, a bend and a barb, connecting a fishing line to the first eyelet, and connecting a leader line to the second eyelet.

Yet another embodiment of the invention is a method of manufacture including providing a shank having a relatively straight portion, a bend and a barb on a first end of the shank, providing a first eyelet to a second end of the shank opposing the first end, and providing a second eyelet to the shank.

### BRIEF DESCRIPTION OF THE DRAWINGS

The present invention is illustrated by way of example and not limitation in the accompanying figures, in which like references indicate similar elements, and in which:

FIG. 1 illustrates a perspective view of a fish hook having first and second eyelets, with the second eyelet located in a bend of the hook, according to certain embodiments;

FIG. 2 illustrates a top view of the fish hook of FIG. 1, according to certain embodiments;

FIG. 3 illustrates a bottom view of the fish hook of FIG. 1, according to certain embodiments;

FIG. 4 illustrates a front side view of the fish hook of FIG. 1, according to certain embodiments;

FIG. 5 illustrates a back side view of the fish hook of FIG. 1, according to certain embodiments;

FIG. 6 illustrates a perspective view of a fish hook having first and second eyelets, with the second eyelet located at intersection of a relatively straight portion and a bend of the hook, according to certain embodiments;

FIG. 7 illustrates a top view of the fish hook of FIG. 6, according to certain embodiments;

FIG. 8 illustrates a bottom view of the fish hook of FIG. 6, according to certain embodiments;

FIG. 9 illustrates a front side view of the fish hook of FIG. 6, according to certain embodiments;

FIG. 10 illustrates a back side view of the fish hook of FIG. 6, according to certain embodiments;

FIG. 11 illustrates a perspective view of a fish hook having first and second eyelets, with the second eyelet located adjacent the first eyelet along the hook, according to certain embodiments;

FIG. 12 illustrates a top view of the fish hook of FIG. 11, according to certain embodiments;

FIG. 13 illustrates a bottom view of the fish hook of FIG. 11, according to certain embodiments;

FIG. 14 illustrates a front side view of the fish hook of FIG. 11, according to certain embodiments;

FIG. 15 illustrates a back side view of the fish hook of FIG. 11, according to certain embodiments;

FIG. 16 illustrates a perspective view of another fish hook including a lateral extension from a first eyelet and a second eyelet located in a bend of the hook, according to certain embodiments;

FIG. 17 illustrates a top view of the fish hook of FIG. 16, according to certain embodiments;

FIG. 18 illustrates a bottom view of the fish hook of FIG. 16, according to certain embodiments;

FIG. 19 illustrates a front side view of the fish hook of FIG. 16, according to certain embodiments;

FIG. 20 illustrates a back side view of the fish hook of FIG. 16, according to certain embodiments;

FIG. 21 illustrates a perspective view of a fish hook including a lateral extension from a first eyelet and a second eyelet located at intersection of a relatively straight portion and a bend of the hook, according to certain embodiments;

FIG. 22 illustrates a top view of the fish hook of FIG. 21, according to certain embodiments;

FIG. 23 illustrates a bottom view of the fish hook of FIG. 21, according to certain embodiments;

FIG. 24 illustrates a front side view of the fish hook of FIG. 21, according to certain embodiments; and

FIG. 25 illustrates a back side view of the fish hook of FIG. 21, according to certain embodiments.

### DETAILED DESCRIPTION

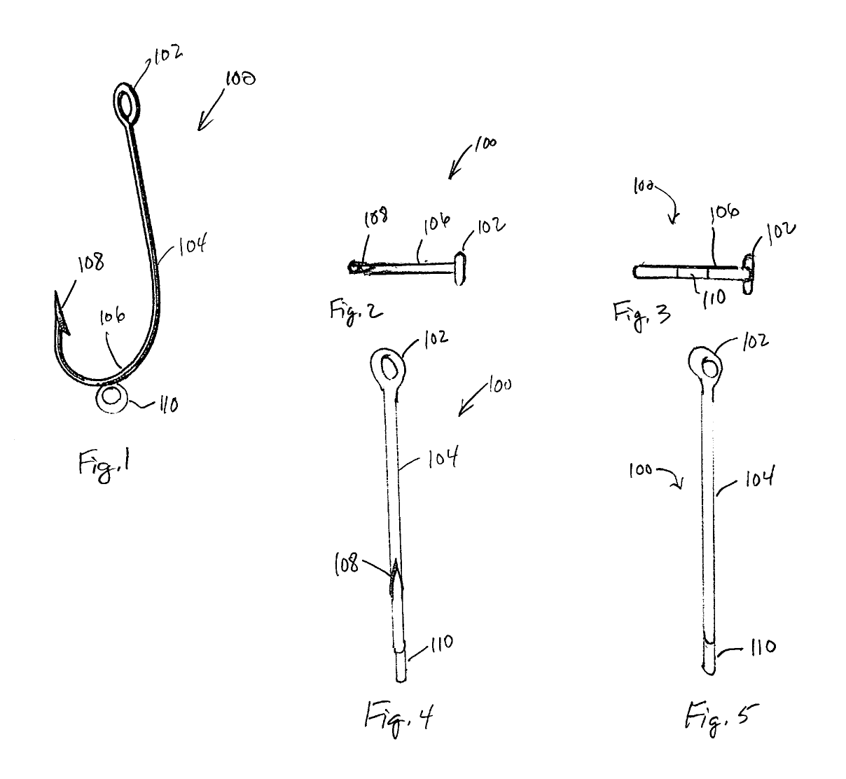

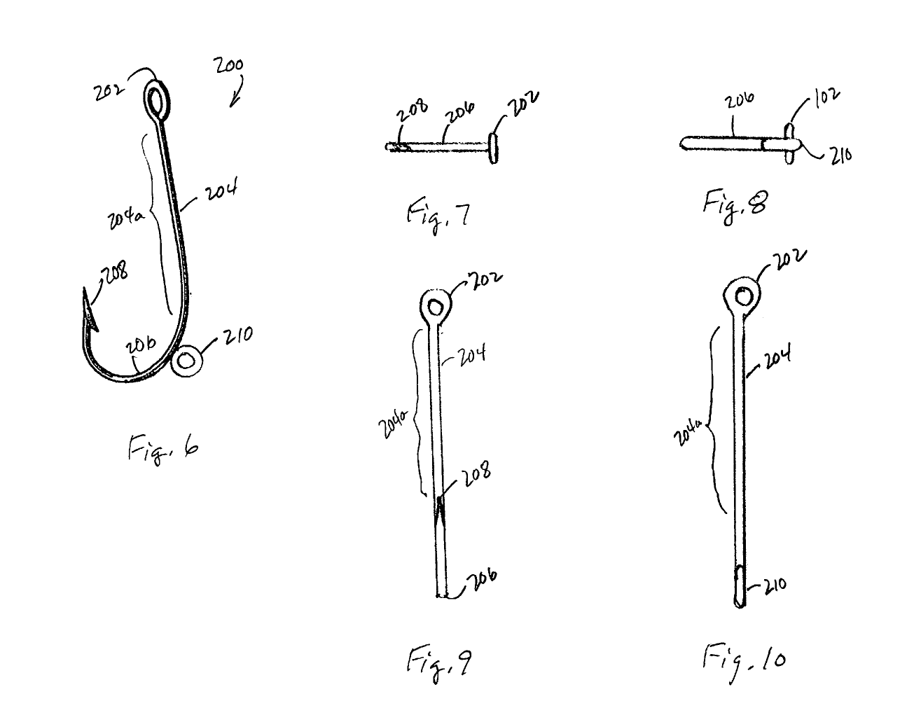

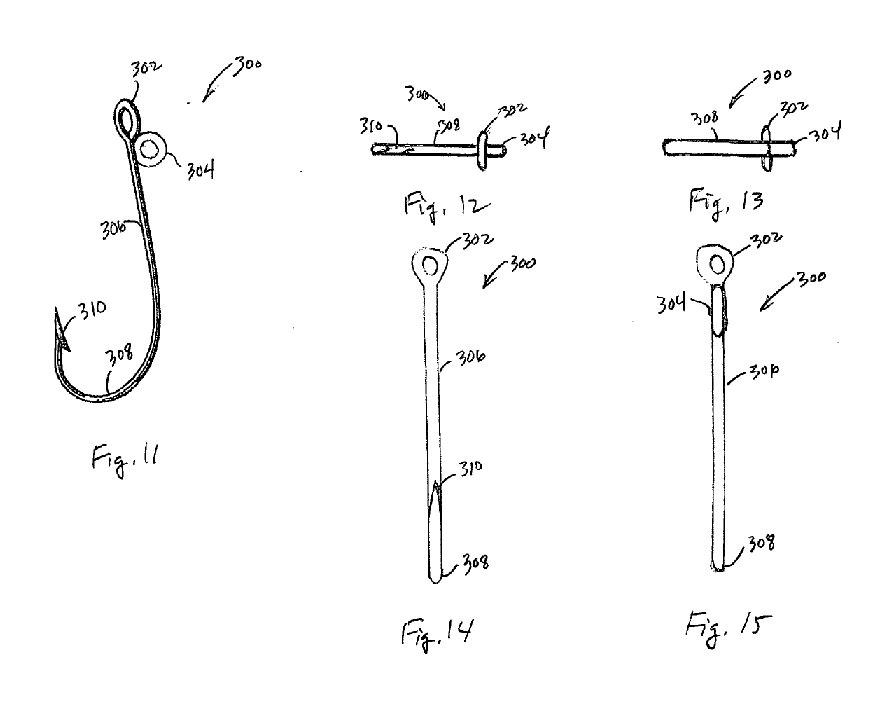

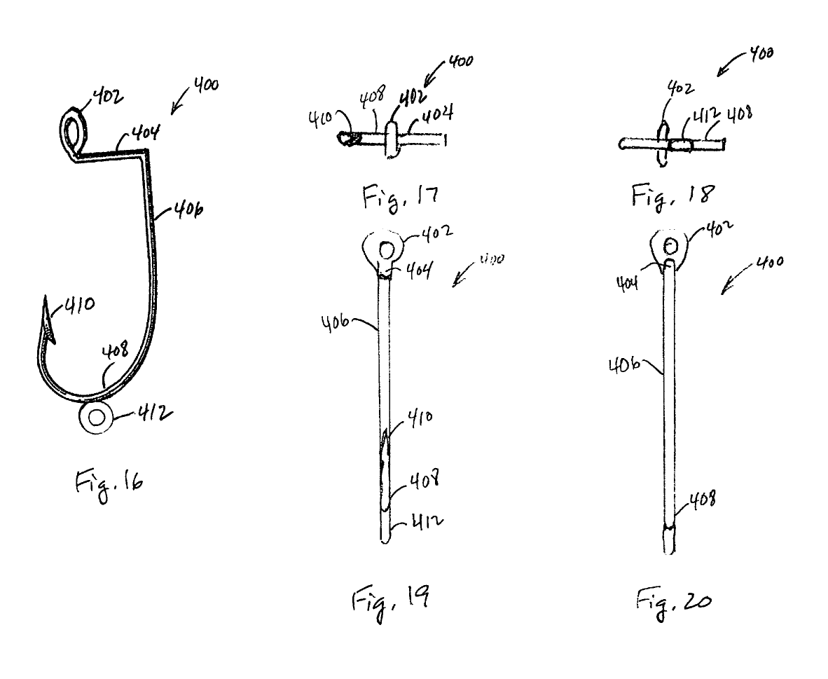

Referring to FIGS. 1-5, a system 100 includes a primary eyelet 102 connected to a shank 104 forming a bend 106 and barb-carrying extent 108. A secondary eyelet 110 is connected to the bend 106 of the shank 104 opposing the primary eyelet 102 and the barb-carrying extent 108. The primary eyelet 102 is configured for attachment to a fishing line extending from a rod and reel or the like. The secondary eyelete 110 is configured for attachment to a leader (not shown in detail) extending from the secondary eyelet 110 to trail an item, such as additional flies, baits, lures, indicators, stimulators or weights, with respect to the system 100.

In operation, a fishing line is connected to the primary eyelet 102. A separate leader line is attached to the secondary eyelet 110. The leader line may include or connect to a fly, bait, lure, indicator, stimulator, weight or other device or item. In use, the system 100 provides a first hook for catching fish and the secondary eyelet 110 permits attachment of a dropped item to the first hook.

Referring to FIGS. 6-10, a system 200 includes a primary eyelet 202 connected to a shank 204 forming a bend 206 and barb-carrying extent 208. The shank 204 includes a relatively straight portion 204a adjacent the primary eyelet 202. A secondary eyelet 210 is connected to the shank 204 at about where the relatively straight portion 204a becomes the bend 206 and opposing the bend 206. The secondary eyelete 210 is configured for attachment to a leader (not shown in detail) extending from the secondary eyelet 210 to trail an item from the system 200.

In operation, the primary eyelet 202 is tied with a fishing line from a rod and reel or other source. A separate leader line is tied to the secondary eyelet 210. The leader line may connect to a second hook, fly, lure, or other device or item. In use, the system 200 provides a first hook for catching fish and a second trailing device or item dropped from the first hook.

Referring to FIGS. 11-15, a system 300 includes a primary eyelet 302. The primary eyelet 302 connects to a shank 306. At about the intersection of the primary eyelet 302 and the shank 306, the shank 306 is connected to a secondary eyelet 304.

The shank 306 extends to opposing the secondary eyelet 304 to a bend 308 and into a barbed extent 310.

In operation, a fishing line is tied to the primary eyelet 302. A separate fishing line leader is tied to the secondary eyelet 304 near the primary eyelet 302. The separate fishing line leader can be connected to a trailing hook, fly, lure or other device or item. The system 300 provides a first fishing hook and the separate leader from the secondary eyelet 304 connects to another item.

Referring to FIGS. 16-20, a system 400 includes a primary eyelet 402 connected to a lateral extension 404 of a shank 406. The shank 406 extends from the lateral extension 404 to form a bend 408 and a barbed extent 410. A secondary eyelet 412 is connected to the bend 408 opposing the primary eyelet 402 and the barbed extent 410.

In operation, the primary eyelet 402 is connected to a fishing line. A separate and additional portion of leader is attached to the second eyelet 412. The leader may connect to a hook, fly, lure, weight, or other device or item. In use, the leader and its attached device or item drops or trails in relation to the system 400.

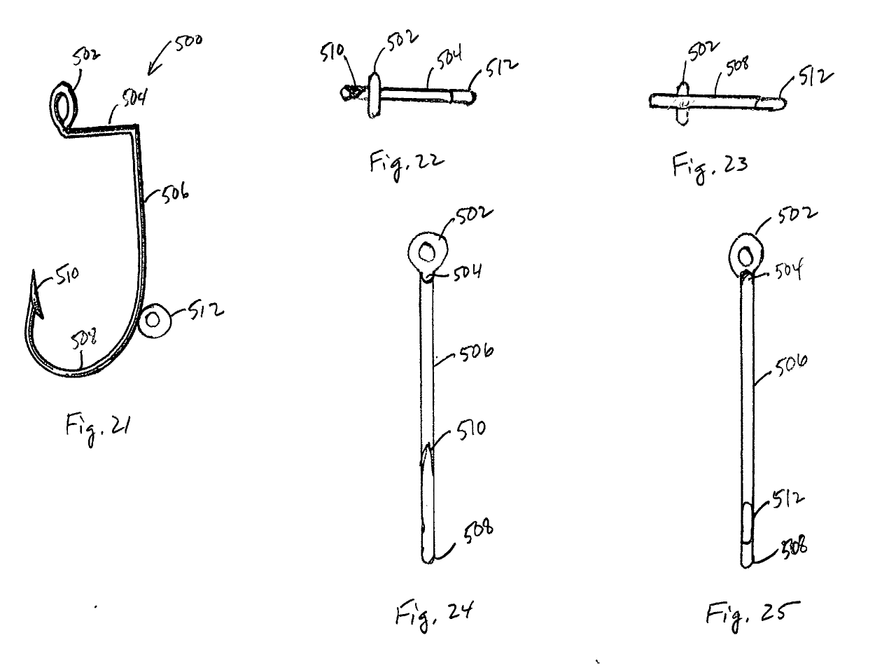

Referring to FIGS. 21-25, a system 500 includes a primary eyelet 502. The primary eyelet 502 is connected to a lateral extension 504 of a shank 506. The shank 506 extends with a generally straight portion from the lateral extension 504, and then forms a bend 508 extending to a barb 510. A secondary eyelet 512 is connected to the shank 506 about where the generally straight portion begins to form the bend 508, and opposing the bend 508 and the barb 510.

In operation, a fishing line is connected to the primary eyelet 502. A separate leader line can be attached to the secondary eyelet 512 of the system 500. The separate leader line can connect to a hook, fly, weight, or other device or item. In use, the separate leader line and connected device or item trails (or drops) beyond the system 500.

The systems 100, 200, 300, 400, 500 can each be formed of wire or molded or extruded metal. The secondary eyelet of the systems can be connected to the shank of the systems by welding or solder, or manufactured integrated with the shank.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system, comprising:
a shank forming a bend and a barb on a first end;
a first eyelet connected to the shank on a second end;
a second eyelet connected to the shank opposing the bend and the barb.

2. The system of claim 1, wherein the second eyelet is located adjacent the first eyelet near the second end.

3. The system of claim 1, wherein the second eyelet is located along the shank near commencement of the bend.

4. The system of claim 1, wherein the second eyelet is located along the bend of the shank diametrically opposed to the first eyelet.

5. A method, comprising:
providing a first eyelet;
providing a bend to a shank connected by a first end to the first eyelet;
providing a barb to a second end of the shank opposite the first eyelet; and
providing a second eyelet to the shank.

6. The method of claim 5, wherein the second eyelet is connected to the shank adjacent the first eyelet and opposing the barb.

7. The method of claim 5, wherein the shank includes a relatively straight portion extending from the first eyelet to the bend;
wherein the second eyelet is connected to the shank near commencement of the bend and opposing the barb.

8. A fish hook, comprising:
a shank forming a relatively straight portion and extending to a bend portion;
a first eyelet at a first end of the relatively straight portion of the shank opposite the bend portion;
a barb at a second end of the bend portion of the shank opposite the relatively straight portion;
a second eyelet connected to the shank.

9. The system of claim 8, wherein the second eyelet is connected to the shank adjacent the first eyelet and opposing the barb.

10. The system of claim 8, wherein the second eyelet is connected to the shank about the connection of the straight portion and the bend and opposing the barb.

11. The system of claim 8, wherein the second eyelet is connected to the bend of the shank opposing the straight portion.

12. A method, comprising:
providing a fish hook including a first eyelet and a second eyelet connected by a shank having a relatively straight portion, a bend and a barb;
connecting a fishing line to the first eyelet;
connecting a leader line to the second eyelet.

13. The method of claim 12, further comprising:
connecting a drop item to the leader line, the drop item is selected from the group consisting of: hook, fly, bait, lure, indicator, stimulator and weight.

14. The method of claim 13, wherein the second eyelet is located adjacent the first eyelet along the shank.

15. The method of claim 13, wherein the second eyelet is located at about intersection of the relatively straight portion and the bend.

16. The method of claim 13, wherein the second eyelet is located at the bend.

17. A method of manufacture, comprising:
providing a shank having a relatively straight portion, a bend and a barb on a first end of the shank;
providing a first eyelet to a second end of the shank opposing the first end;
providing a second eyelet to the shank.

18. The method of manufacture of claim 17, wherein providing the second eyelet connects the second eyelet to the shank adjacent the first eyelet and opposing the barb.

19. The method of manufacture of claim 17, wherein providing the second eyelet connects the second eyelet to the shank about instersection of the relatively straight portion and the bend and opposing the barb.

20. The method of manufacture of claim 17, wherein providing the second eyelet connects the second eyelet to the bend opposing the relatively straight portion.
